(19) United States
(12) Patent Application Publication
(10) Pub. No.: US 2012/0090384 A1
(43) Pub. Date: Apr. 19, 2012

(54) Carbon Deposit Simulation Bench And Methods Therefor

(75) Inventor: Orhan Altin, Peoria, IL (US)

(73) Assignee: CATERPILLAR INC., Peoria, IL (US)

(21) Appl. No.: 12/905,432

(22) Filed: Oct. 15, 2010

(51) Int. Cl. G01N 17/00; G01N 11/00

(52) U.S. Cl. 73/53.01; 73/865.6

(57) ABSTRACT

A carbon deposit simulation bench for evaluating effects of an engine system liquid on an engine surface that experiences an engine pressure and an engine temperature includes a test chamber having a high surface area test specimen positioned therein. The carbon deposit simulation bench also includes an air supply system including an air supply conduit fluidly connecting an air supply source with the test chamber, and a liquid circulation loop configured to circulate the engine system liquid through the test chamber. A temperature control subsystem simulates the engine temperature within the test chamber, and a pressure control subsystem simulates the engine pressure within the test chamber.

### TECHNICAL FIELD

The present disclosure relates generally to a carbon deposit simulation bench, and more particularly to a carbon deposit simulation bench for evaluating effects of an engine system liquid on an engine surface.

### BACKGROUND

Thermal stability of engine system liquids, including hydrocarbons, such as oil and fuel, is an important consideration regarding performance and maintenance of internal combustion engines. Specifically, the decomposition of engine system liquids and their reactions to engine surfaces, such as metallic surfaces, at high engine operating temperatures may lead to the formation of carbon deposits on various engine surfaces. These deposits may remain on the engine surfaces or become suspended in the engine system liquid and carried to other parts of the system. Of specific concern is the deposition or collection of carbon deposits on critical engine surfaces, such as those within combustion systems and fuel delivery systems of the engine. Degradation of these engine system liquids resulting in carbonaceous deposits, particularly on or near critical engine surfaces, may affect engine performance and could possibly lead to engine malfunction or failure.

Past efforts have been made to simulate an engine environment for testing carbon deposit formation tendencies of engine system liquids. For example, U.S. Pat. No. 5,337,599 to Hundere et al. discloses a test device for evaluating the thermal oxidation characteristics of jet fuels.

The present disclosure is directed to one or more of the problems set forth above.

### SUMMARY OF THE DISCLOSURE

In one aspect, a carbon deposit simulation bench for evaluating effects of an engine system liquid on an engine surface that experiences an engine pressure and an engine temperature includes a test chamber having a high surface area test specimen positioned therein. The carbon deposit simulation bench also includes an air supply system including an air supply conduit fluidly connecting an air supply source with the test chamber, and a liquid circulation loop configured to circulate the engine system liquid through the test chamber. A temperature control subsystem simulates the engine temperature within the test chamber, and a pressure control subsystem simulates the engine pressure within the test chamber.

In another aspect, a method for setting up a carbon deposit simulation bench includes simulating a temperature of an engine surface within a test chamber using a temperature control subsystem, and simulating a pressure of the engine surface within the test chamber using a pressure control subsystem. The method also includes running the carbon deposit simulation bench using a first baseline liquid for a predetermined period of time, and comparing a first deposit signature from the first baseline liquid within the test chamber to an expected engine deposit signature corresponding to the first baseline liquid. Steps one through four are repeated at different combinations of temperature and pressure until the first deposit signature from the first baseline liquid matches the expected engine deposit signature.

In yet another aspect, a method for evaluating an engine system liquid using a carbon deposit simulation bench includes simulating a temperature of an engine surface within the test chamber using a temperature control subsystem, and simulating a pressure of the engine surface within the test chamber using a pressure control subsystem. The method also includes running the carbon deposit simulation bench using the engine system liquid for a predetermined period of time, calculating a mass of deposits from the engine system liquid on a high surface area test specimen, and comparing the mass of deposits from the engine system liquid on the high surface area test specimen to a baseline mass of deposits.

### BRIEF DESCRIPTION OF THE DRAWINGS

FIG. 1 is a schematic of a carbon deposit test bench, according to the present disclosure;

FIG. 2 is a partial perspective view of an exemplary embodiment of a test chamber of the carbon deposit test bench of FIG. 1;

FIG. 3 is a perspective view of an exemplary embodiment of an engine piston surface that may experience carbon deposits;

FIG. 4 is a perspective view of an exemplary embodiment of a fuel injector component surface that may experience carbon deposits;

FIG. 5 is a line graph of carbon dioxide intensity versus temperature illustrating matching deposit signatures;

FIG. 6 is a line graph of carbon dioxide intensity versus temperature illustrating deposit signatures that do not match; and

FIG. 7 is a bar graph illustrating the mass of deposits for several engine system liquids, including a low level baseline and a high level baseline.

### DETAILED DESCRIPTION

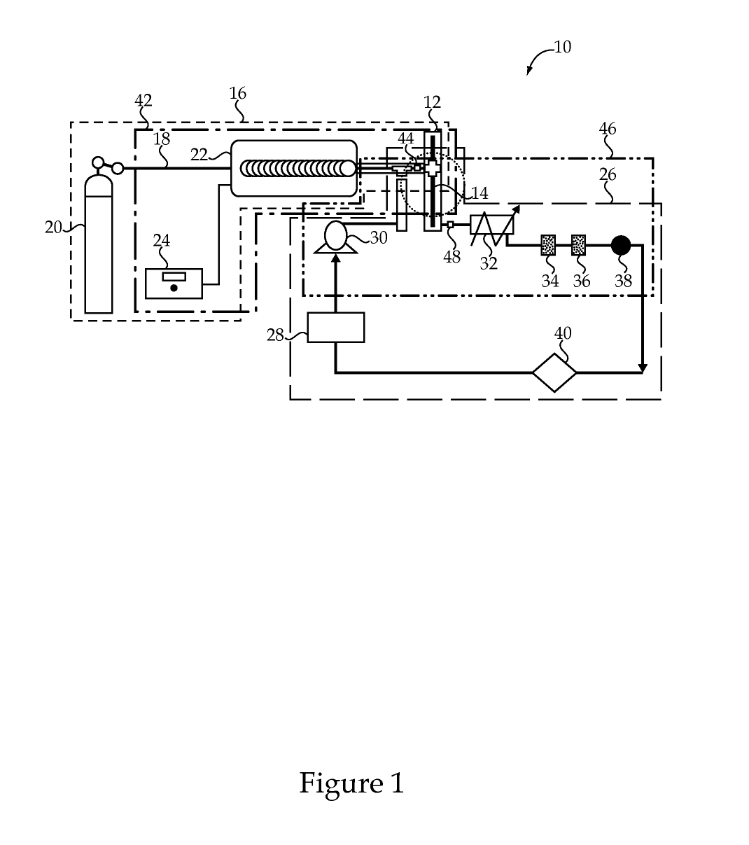

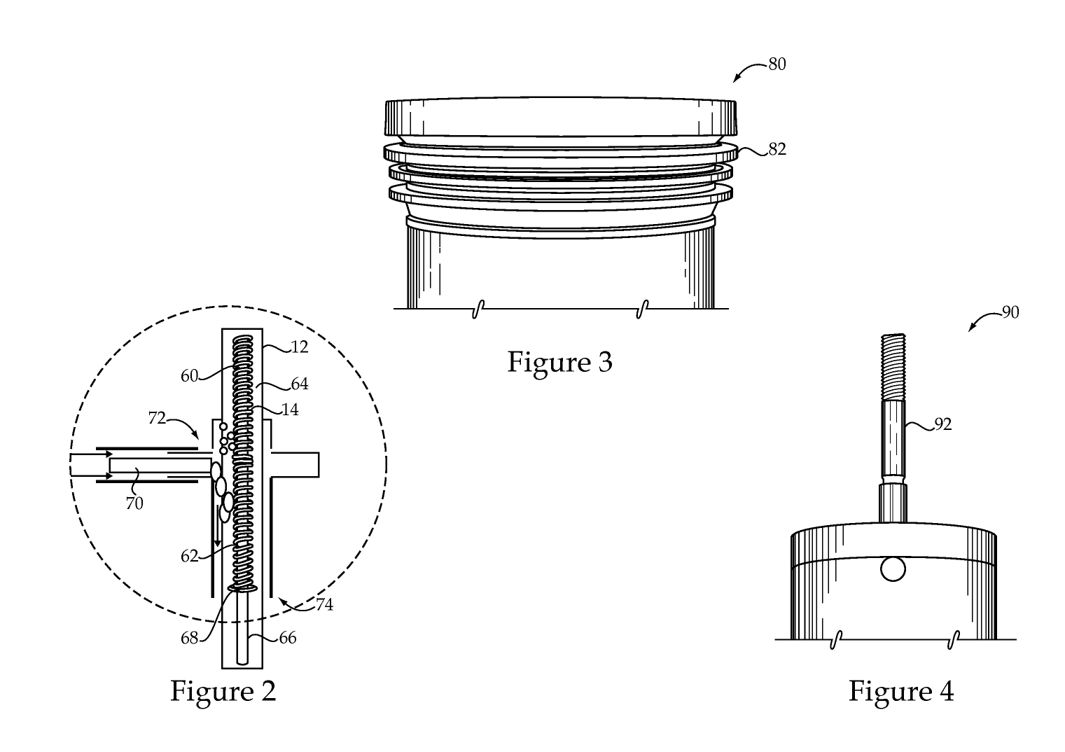

An exemplary embodiment of a carbon deposit simulation bench 10 for evaluating effects of an engine system liquid on an engine surface is shown generally in FIG. 1. The engine system liquid may include a hydrocarbon, such as oil or fuel, or any other liquid commonly circulated through any engine system of an internal combustion engine. Although this disclosure may be applicable for simulating deposits on surfaces of any engine, the described embodiment was specifically designed to simulate deposits on surfaces of a compression ignition engine burning distillate diesel fuel having a variety of additives that may or may not contribute to deposit formation. The carbon deposit simulation bench 10 includes a test chamber 12 having a high surface area test specimen 14 positioned therein. Both the test chamber 12 and the high surface area test specimen 14 will be discussed in greater detail below with regard to FIG. 2.

An air supply system 16 for the carbon deposit simulation bench 10 includes an air supply conduit 18 fluidly connecting an air supply source 20, such as a tank or a compressor, with the test chamber 12. According to the exemplary embodiment, the air supply system 16 may include an air heating device 22 disposed along the air supply conduit 18 and an electronic temperature controller 24 for adjusting the temperature of the air heating device 22. The air heating device 22 may include any well known heating source, such as, for example, a heating element utilizing electricity, or another heating source utilizing an alternative fuel source. According to one embodiment, the air heating device 22 may include a tubular heating furnace utilizing electrical resistance as the heating source. The level of heat produced by the air heating device 22 may be controlled by a thermostat, or any other well known device for regulating temperature, which may be integral with or responsive to the electronic temperature controller 24.

The carbon deposit simulation bench 10 also includes a liquid circulation loop, an example of which is shown at 26. The liquid circulation loop 26 is configured to circulate and, more specifically, recirculate the engine system liquid through the test chamber 12 and may, according to the exemplary embodiment, include the following components fluidly connected in series: a liquid container 28, a liquid pump 30, the test chamber 12, a heat transfer device 32, one or more filters, such as filters 34 and 36, a back pressure regulator 38, and a separator 40. Although a specific embodiment is shown, it should be appreciated that any similar loop capable of recycling an engine system liquid and recirculating the liquid through the test chamber 12, as described herein, may be used with the carbon deposit simulation bench 10.

The liquid pump 30, which draws an engine system liquid, such as, for example, oil or fuel, from the liquid container 28, may preferably include a high pressure liquid metering pump. An example of such a pump includes an Optos Series pump offered by Eldex Laboratories, Inc., headquartered in Napa, Calif. The Optos Series pump provides flow rates between 0.002 to 80 mL/min using a reciprocating piston design, and provides high pressure capabilities, including pressures up to 6000 psi, and is made from corrosion resistant materials. The Eldex Optos pump is provided as an example only and those skilled in the art should appreciate that any pump capable of pumping an engine system liquid through the test chamber 12 at precise flow rates and high pressures may be utilized.

After the engine system liquid is circulated through the test chamber 12, it may be routed through the heat transfer device 32. The heat transfer device 32 may include a well known condenser or any other device capable of cooling the engine system liquid using any of a variety of well known coolants. Before being routed into the heat transfer device 32, the temperature of the engine system liquid may be measured using a heat sensor, such as a thermocouple. By first measuring the temperature of the engine system liquid, operation of the heat transfer device 32 may be controlled to ensure that the engine system liquid is cooled sufficiently prior to circulation through the back pressure regulator 38.

One or more filters, such as filters 34 and 36 may be provided for capturing deposits carried by the engine system liquid. Specifically, carbonaceous materials deposited on the high surface area test specimen 14 may break away as a result of the flow of the engine system liquid through the test chamber 12 and may be carried by the engine system liquid. Such deposits may affect the performance of the back pressure regulator 38 and/or other components within the liquid circulation loop 26. According to the exemplary embodiment, a first filter 34 may be provided for capturing larger deposit particles, while a second filter 36 may be provided for capturing smaller deposit particles. For example, the first filter 34 may include a 40 μm stainless steel filter manufactured by Swagelok Company, headquartered in Solon, Ohio, while the second filter 36 may include a 7 μm stainless steel filter, also manufactured by Swagelok Company. Although specific examples are provided, it should be appreciated that one or more alternative filters may be substituted for first and second filters 34 and 36.

The back pressure regulator 38 may include any pressure regulating device capable of maintaining a desired pressure inside the test chamber 12. According to one example, the back pressure regulator 38 may include a BP-60 back pressure regulator manufactured by GO Regulator, headquartered in Spartanburg, S.C. The BP-60 back pressure regulator is a high pressure back pressure regulator having adjustable control ranges of 500, 1000, and 2000 psig. It should be appreciated, however, that any pressure reducing regulator designed for high pressure systems and capable of maintaining a desired pressure within the test chamber 12 may be utilized with carbon deposit simulation bench 10.

The liquid circulation loop 26 may also include the separator 40 for separating air from the engine system liquid. Separators, such as separator 40, are well known and may include any device for separating an air-liquid mixture. After air is removed from the engine system liquid, the engine system liquid may be returned to the liquid container 28. The liquid circulation loop 26, in combination with the air supply system 16 and other systems or subsystems of the carbon deposit simulation bench 10, is designed to simulate an engine environment in which an engine system liquid is circulated through an engine system and exposed to an engine surface. Specifically, within the engine environment, the engine system liquid is typically filtered, stored, and recirculated after initial circulation. Additional devices, such as heat exchangers and separators, may be provided for improving performance of one or more components within the carbon deposit simulation bench 10.

The carbon deposit simulation bench 10 also includes a temperature control subsystem, shown generally at 42, for simulating a temperature, also referred to as an engine temperature, of an engine surface within the test chamber 12. The temperature control subsystem 42 may include means for adjusting the air heating device 22 to maintain a desired temperature within test chamber 12. For example, the temperature control subsystem 42 may include the air heating device 22, the electronic temperature controller 24, and a temperature sensor 44, such as a thermocouple, used to measure the temperature at or near the test chamber 12. In response to the temperature detected by temperature sensor 44, the electronic temperature controller 24 may cause the air heating device 22 to increase or decrease the amount of heat produced in order to raise or lower the temperature of the air supplied along air supply conduit 18. By adjusting the temperature of the air introduced into test chamber 12 and mixed with the engine system liquid, a desired temperature within the test chamber 12 may be achieved and, preferably, maintained. The desired temperature may, for example, represent an average engine temperature experienced by a specific engine surface during engine operation. Thus, one could expect the temperature in the test chamber 12 to oscillate about a desired average engine temperature during a simulation run. For example, it may be desirable to maintain a desired average engine temperature plus or minus 5 degrees Celsius. If the variance on the controlled temperature is large and the test results are unacceptable, tighter control of temperature may be desired.

A pressure control subsystem 46 is provided for simulating a pressure, also referred to as an engine pressure, within the test chamber 12. The pressure control subsystem 46 may include means for adjusting the liquid pump 30 and/or back pressure regulator 38 to achieve and, preferably, maintain a desired pressure within the test chamber 12. For example, the pressure control subsystem 46 may include the liquid pump 30, the back pressure regulator 38, and a pressure gauge 48, or other similar device, used to measure the pressure at or near the test chamber 12. According to one embodiment, the pressure control subsystem 46 may include pressure gauge 48 positioned upstream of the test chamber 12, and an additional pressure gauge positioned downstream of the test chamber 12. The liquid pump 30 and/or back pressure regulator 38 may be adjusted responsive to the pressure detected by one or more pressure gauges, such as pressure gauge 48. According to one embodiment, for example, the desired pressure may represent an average engine pressure experienced by a specific engine surface during engine operation. Thus, one could expect the pressure in the test chamber 12 to oscillate about a desired average engine pressure during a simulation run. For example, it may be desirable to maintain a desired average engine pressure plus or minus 25 psig. If the variance on the controlled pressure is large and the results in an unacceptable simulation, tighter control of pressure may be desired.

Turning now to FIG. 2, an exemplary embodiment of the test chamber 12, including the high surface area test specimen 14, is shown. The high surface area test specimen 14, according to a preferred embodiment, may include a spring, such as a compression spring. Although one spring may be utilized, the exemplary embodiment depicts two springs, namely, a first spring 60 and a second spring 62. Specifically, for example, the test chamber 12 may define a shaft 64 having a vertically aligned rod 66 supported therein. The first and second springs 60 and 62 may be positioned around the vertically aligned rod 66 and supported at a selected height along the vertically aligned rod 66 using a suitable retainer, such as retaining ring 68. Although the retaining ring 68 may not be used in all embodiments, it may be included to ensure consistent positioning of the high surface area test specimen 14 within the test chamber 12 throughout numerous tests, or runs, of the carbon deposit simulation bench 10. During a test, or run, of the carbon deposit simulation bench 10, an engine system liquid 70 may flow into the test chamber 12 at an entry passage 72 and exit the test chamber 12 through an exit passage 74. Although the illustrated embodiment shows the engine system liquid 70 entering the test chamber 12 perpendicularly to the shaft 64 and exiting the test chamber 12 along a flow path that is parallel to the shaft 64, other configurations for exposing the high surface area test specimen 14 to the engine system liquid 70 are contemplated.

The first and second springs 60 and 62, according to one example, may include stainless steel compression springs manufactured by W.W. Grainger, Inc., headquartered in Lake Forest, Ill., having a 1½ inch overall length, 0.240 inch outside diameter, and 0.042 wire diameter. The retaining ring 68 may also be manufactured by W.W. Grainger, Inc., and may include a self locking, stainless steel retaining ring made for the diameter of vertically aligned rod 66, which may also be made from stainless steel. It should be appreciated that the specific components of test chamber 12 are provided for exemplary purposes only, and that an alternative high surface area test specimen 14 may be used in test chamber 12.

The high surface area test specimen 14 preferably provides greater surface area than other similarly sized test specimens upon which carbonaceous deposits may form and collect. For example, a spring, as suggested above, may be desirable over a commonly used test tube since a spring has more surface area per unit length than a tube. For purposes of this disclosure, a high surface area test specimen, such as high surface area test specimen 14, is something other than a tube. It is also preferable that the high surface area test specimen 14 be made from a stainless steel, or other strong and inert material, since it may be exposed to high temperatures and pressures. In some embodiments, which will be described below, it may be desirable to select a material for the high surface area test specimen 14 that is the same as the engine surface material being simulated.

Although one high surface area test specimen 14 may be used, it should be appreciated that a greater number of test specimens may be desirable, depending on the testing to be conducted after running the carbon deposit simulation bench 10. For example, two springs 62 and 64 may be provided so that two different tests may be conducted on the deposits collected on the springs 62 and 64. If only one high surface area test specimen 14 were provided, it may be necessary to cut the test specimen 14 in order to perform the different tests. As should be appreciated, cutting the high surface area test specimen 14 may contaminate test results, such as by causing some deposits to break loose from the test specimen 14.

Referring to FIG. 3, the engine surface described herein may include a surface of an engine piston 80. Specifically, deposits may form and/or accumulate on a top land, or top groove, 82 of the engine piston 80. As such, it may be desirable to use the carbon deposit simulation bench 10 to simulate the environment at or near the top land 82 of the engine piston 80 and evaluate the effects of an engine system liquid, such as, for example, a lubricating oil, on the top land 82. According to such an embodiment, the temperature control subsystem 42 may be configured to maintain the average engine temperature corresponding to the engine piston 80 or, more specifically, the top land 82 of the engine piston 80. The pressure control subsystem 46 may be configured to maintain the average engine pressure corresponding to the top land 82 of the engine piston 80. Further, a material of the high surface area test specimen 14, which may include springs 62 and 64, may be the same as a material of the engine piston 80. This may be desirable since combustion chambers and the engine pistons operating therein are subject to high temperatures, such as temperatures exceeding 250 degrees Celsius. At these higher temperatures, the specific surface material itself may contribute to deposit formation, whereas, below these temperatures, deposit formation is far less sensitive to the specific material of the surfaces.

Alternatively, and referring to FIG. 4, the engine surface may include an internal surface of a fuel injector component 90. Specifically, according to one example, deposits may form and/or accumulate on the inner diameter of an upper housing and/or a valve surface 92 within a fuel injector. Since fuel injectors are designed to accurately meter fuel to the engine and deliver it in a precise pattern, it should be appreciated that the fuel injector components are highly sensitive to even small amounts of deposits in critical regions where the fuel is metered and atomized. To simulate the environment at or near the valve surface 92, the temperature control subsystem 42 may be configured to maintain the average engine temperature corresponding to the fuel injector component 90 or, more specifically, the valve surface 92. The pressure control subsystem 46 may be configured to maintain the average engine pressure corresponding to the valve surface 92 of the fuel injector component 90. Further, a material of the high surface area test specimen 14 may be different from a material of the fuel injector component 90 since temperatures within the fuel injector may remain below 200 degrees Celsius. The present disclosure recognizes that in real engines, air is dissolved in the fuel that circulates through fuel injectors. Thus, the carbon deposit simulation bench 10 circulates fuel mixed with air through the test chamber 12, even though internal fuel injector surfaces are rarely exposed to gaseous air. The simulation results have, nevertheless, been shown to be valid.

The carbon deposit simulation bench 10 may be set up by first simulating a temperature of an engine surface within the test chamber 12 using the temperature control subsystem 42, and simulating a pressure of the engine surface within the test chamber 12 using the pressure control subsystem 46. For example, if the carbon deposit simulation bench 10 is being used to simulate a surface of the engine piston 80, it may be desirable to maintain a temperature of approximately 250 degrees Celsius and a pressure of approximately 1000 psig. If the carbon deposit simulation bench 10 is being used to simulate a surface of the fuel injector component 90, it may be desirable to maintain a temperature of approximately 200 degrees Celsius and a pressure of approximately 1000 psig. As should be appreciated, these temperatures and pressures are provided as examples only and any selected temperatures and pressures will be highly dependent upon the application and conditions to which the engine surface is exposed.

To further improve the simulation, it may be desirable to also simulate average flow rates of the engine system liquid and air. For example, it may be desirable to simulate the flow rates experienced at or near the engine surface being tested. According to one example, it may be desirable to operate the carbon deposit simulation bench 10 at a 2.5 mL/min oil flow rate and a 25 mL/min air flow rate if simulating a surface of the engine piston 80. If simulating a surface of a fuel injector component 90, it may be desirable to operate the carbon deposit simulation bench 10 at a 5 mL/min fuel flow rate and a 25 mL/min air flow rate. It should be appreciated that there is typically no air inside the fuel injector, other than dissolved air within the fuel; however, utilizing air in a fuel injector component simulation may increase decomposition of the fuel and reduce the time required to run the test. According to both examples, it may be desirable to circulate approximately 300 mL of the engine system liquid through the carbon deposit simulation bench 10. In the case of simulating a surface of an engine piston 80, a fixed volume of engine system liquid may be recirculated many times during a simulation run. On the other hand, the engine system liquid used for testing an internal surface of a fuel injector component 90 may not be recirculated, as fuel in the engine is generally circulated only once before being injected and burned. As should be appreciated, the engine system liquid may include additives, such as detergent and antioxidant type additives, used to inhibit solid deposition.

In addition, it may be desirable to preheat the engine system liquid lines of liquid circulation loop 26 and air supply conduit 18 upstream of the test chamber 12 to assist in obtaining a desired and uniform temperature within the test chamber 12. It may also be desirable to clean the test chamber 12 before each use, such as by cleaning the components of the test chamber 12 with heptane in an ultrasonic bath for approximately 30 minutes, to reduce contamination of results. In general, it may be desirable for all wetted surfaces of the simulator to be relatively inert and non-reactive. Stainless steel has been shown to provide acceptable results, but other materials are contemplated.

The carbon deposit simulation bench 10 may be run for a predetermined period of time at the approximate temperature, pressure, and flow rates described above, depending on the engine system liquid and engine surface being evaluated. Specifically, according to one example, the carbon deposit simulation bench 10 may be run using a first baseline liquid, or engine system liquid, for a predetermined period of time, such as, for example, approximately 5 hours. The first baseline liquid may be an oil or fuel, or other hydrocarbon, the effects of which are being evaluated as described herein. After circulating the first baseline liquid through the carbon deposit simulation bench 10 for the predetermined period of time, a first deposit signature from the first baseline liquid within the test chamber 12 may be compared to an expected engine deposit signature corresponding to the first baseline liquid.

When evaluating the deposits formed on the high surface area test specimen 14 with expected deposits, such as deposits evaluated from actual engines, it may be desirable to consider both the carbon and ash contents of the deposits and the carbon burn off profiles of the deposits. For example, carbon and ash contents of deposits formed on the high surface area test specimen 14 and deposits from the actual engine should be similar. It should be appreciated that the ash may result from the decomposition of additives, such as Ca, Zn, and P, containing oxides and sulfates. For example, 50% of both deposits being evaluated may be ash and 50% may be carbon. In addition, deposit signatures, which may represent burn off profiles, for deposits formed on the high surface area test specimen 14 and deposits from the actual engine should be similar. If the signatures are too dissimilar, the simulation may be considered invalid. Such burn off profiles may be determined using the known process of temperature programmed oxidation (TPO). The temperature programmed oxidation may be performed by burning the deposits under 750 mL/min O₂ flow with a heating rate of 30 degrees Celsius/min from 100 degrees Celsius to 900 degrees Celsius.

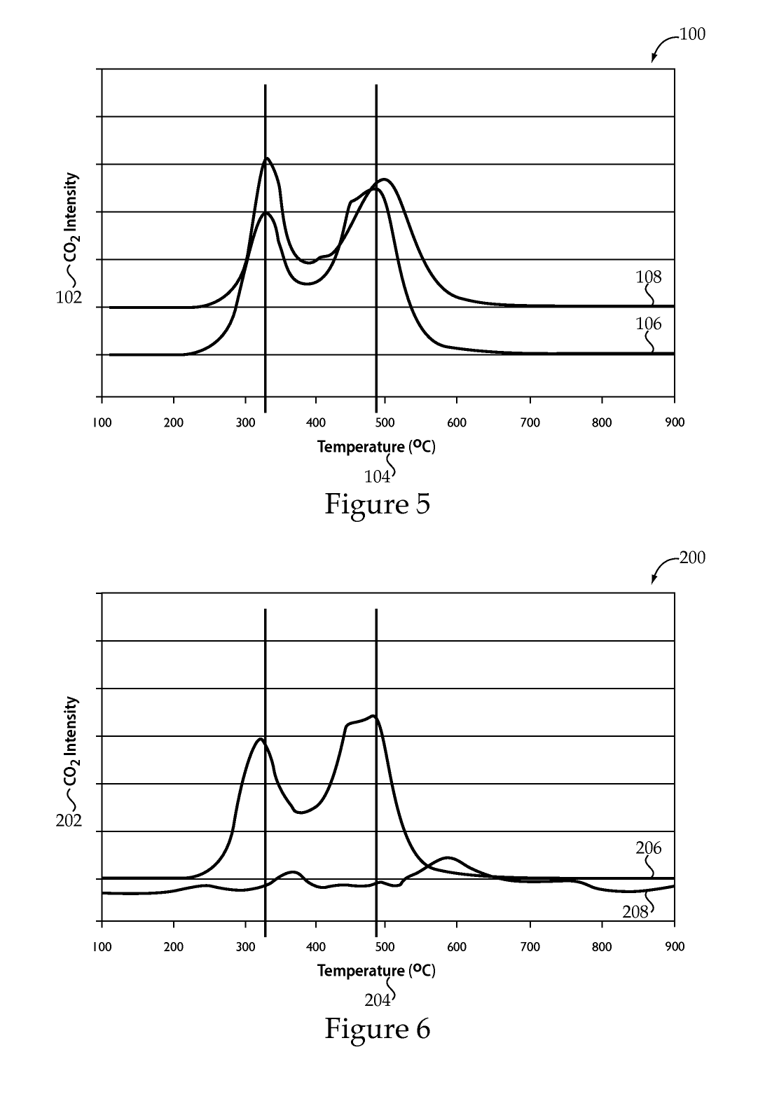

FIG. 5 illustrates a graph 100 of CO₂ intensity 102, shown on the vertical axis, versus temperature 104, shown on the horizontal axis. Depicted on the graph 100 is an expected engine deposit signature 106 corresponding to the first baseline liquid. The expected engine deposit signature 106 may be determined by evaluating deposits from actual engines, or may be provided by a manufacturer of the engine or engine system liquid based on similar evaluations. Also depicted on the graph 100 is a first deposit signature 108 from the first baseline liquid on the high surface area test specimen 14 within the test chamber 12. The first deposit signature 108 is compared to the expected engine deposit signature to determine if they are a match. It should be appreciated that a match may be determined with respect to the deposit signatures in FIG. 5 by comparing both an amorphous deposit peak and an ordered peak and determining they are substantially similar. However, alternative comparisons may be used to determine if a match exists. Those skilled in the art will appreciate that confidence in the validity of the simulation ought to be correlated to how well the “test” signatures match the “expected” signatures. In the context of the present disclosure, a “match” means that the simulation deposits can be used to accurately predict actual deposits in an actual engine.

FIG. 6 illustrates an example of when a match may not exist between the deposit signatures. Specifically, FIG. 6 depicts a graph 200 of CO₂ intensity 202, shown on the vertical axis, versus temperature 204, shown on the horizontal axis. Depicted on the graph 200 is an expected engine deposit signature 206 corresponding to the first baseline liquid. Also depicted on the graph 200 is a first deposit signature 208 from the first baseline liquid on the high surface area test specimen 14 within the test chamber 12. Because the amorphous deposit peak and ordered peak are not substantially similar, it may be determined that the expected engine deposit signature 206 and the first deposit signature 208 do not match. It may also be important to compare the ratio of areas under the amorphous deposit peak and the ordered peak when making a comparison.

The above described steps may be repeated until the first deposit signature, such as 108 or 208, from the first baseline liquid matches the expected engine deposit signature, such as 106 or 206. If the deposit signatures do not match, as shown in FIG. 6, it may be desirable to adjust one or more of the parameters of the carbon deposit simulation bench 10 and perform another simulation. For example, the above steps may be repeated at different combinations of temperature and pressure until the first deposit signature, such as 108 or 208, from the first baseline liquid matches the expected engine deposit signature, such as 106 or 206. Of course, additional parameters, including air flow rates and liquid flow rates, may also be adjusted. When the deposit signatures match, or substantially match, it may be determined that a good simulation has been conducted. If a good simulation has been conducted, it may be desirable to record the “setup” of the carbon deposit simulation bench 10. As used herein, the bench “setup” may include the approximate temperature, pressure, and flow rates, as described above, which are found to produce an acceptable simulation.

After a good simulation has been conducted, it may be desirable to calculate a mass of the deposits from the first baseline liquid on the high surface area test specimen 14. If it has been proven or suggested that the first baseline liquid produces a high level of deposits within the engine, it may be desirable to correlate the mass of deposits from the first baseline liquid on the high surface area test specimen 14 to a high level baseline. The high level baseline may be used as a point of comparison for the testing of additional engine system liquids, as will be described below.

The carbon deposit simulation bench 10 may be run using a second baseline liquid, or engine system liquid, for the predetermined period of time. The second baseline liquid may be an oil or fuel, or other hydrocarbon, the effects of which are being evaluated as described herein. A mass of deposits from the second baseline liquid on the high surface area test specimen 14 may be calculated. Further, if it is found that the second baseline liquid produces a low level of deposits within the engine, it may be desirable to correlate the mass of deposits from the second baseline liquid on the high surface area test specimen 14 to a low level baseline. The low level baseline may be used as an additional point of comparison for the testing of additional engine system liquids, as will be described below.

The carbon deposit simulation bench 10 may be used to evaluate one or more liquids after the carbon deposit simulation bench 10 has been set up. In a similar manner to that described above with respect to setting up the carbon deposit simulation bench 10, the carbon deposit simulation bench 10 may be used by first simulating a temperature, such as an average engine temperature, of an engine surface within the test chamber 12 using the temperature control subsystem 42, and simulating a pressure, such as an average engine pressure, of the engine surface within the test chamber 12 using the pressure control subsystem 46.

The carbon deposit simulation bench 10 may then be run using a first engine system liquid for a predetermined period of time. The first engine system liquid may be an oil or fuel, or other hydrocarbon, the effects of which are being evaluated. A mass of deposits from the first engine system liquid on the high surface area test specimen 14 may be calculated. Further, if it may be desirable to compare the mass of deposits from the first engine system liquid on the high surface area test specimen 14 to a baseline mass of deposits. More specifically, for example, it may be desirable to compare the mass of deposits from the first engine system liquid to one or both of the high level baseline and the low level baseline.

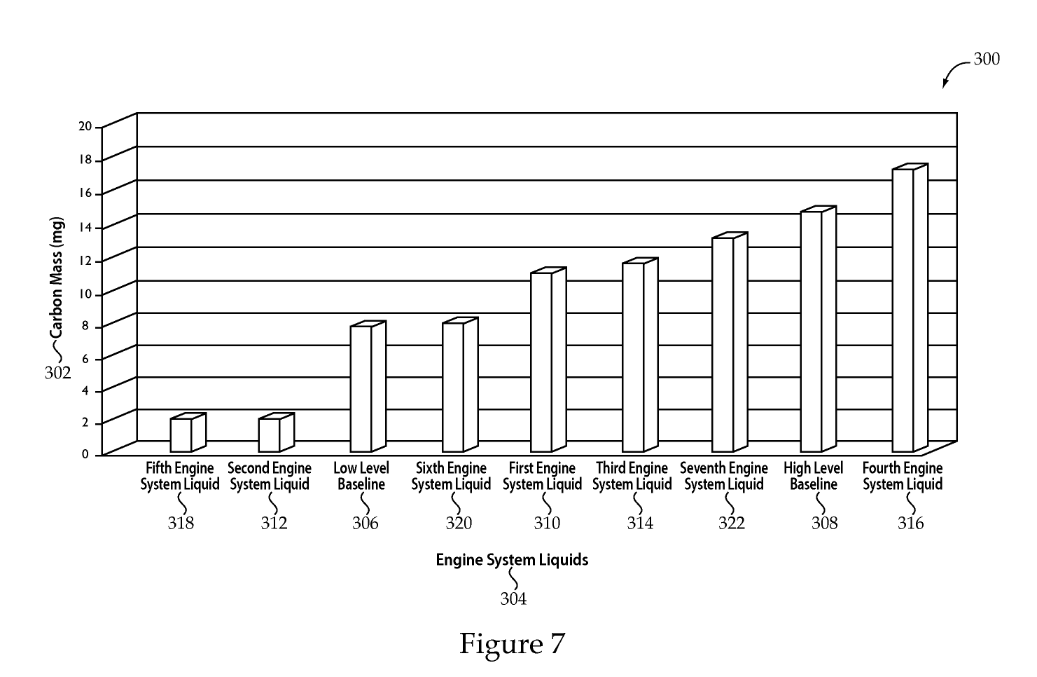

FIG. 7 illustrates a graph 300 of carbon mass 302, shown on the vertical axis, versus engine system liquids 304, shown on the horizontal axis. Depicted on the graph 300 are a deposit mass for a low level baseline 306 and a deposit mass for a high level baseline 308. Also depicted on the graph 300 are an exemplary deposit mass for each of seven engine system liquids 310-322. As should be appreciated, by comparing each engine system liquid 310-322 that is tested to the low level baseline 306 and the high level baseline 308, the carbon deposit formation tendencies of the engine system liquids 310-322 within an engine environment may be evaluated. In other words, deposit behavior, including quantity and chemistry, of the non-baseline liquids can be predicted for an actual engine based upon the comparison to the baseline liquids. For instance, one might predict liquid 316 to produce deposits in a real engine in excess of the high baseline liquid 308. On the other hand, one might expect liquid 312 to produce less than one third of the deposits associated with low baseline liquid 306 if used in a real engine.

### Industrial Applicability

The present disclosure may find potential application to the evaluation of engine system liquids, such as hydrocarbons. Further, the present disclosure may be particularly applicable to the evaluation of carbon deposits from the engine system liquids on particular engine surfaces. Yet further, the present disclosure may be applicable to the simulation of an engine environment to evaluate the carbon deposit formation tendencies of engine system liquids on particular engine surfaces.

Referring generally to FIGS. 1-7, an exemplary carbon deposit simulation bench 10 may include a test chamber 12 having a high surface area test specimen 14 positioned therein. The carbon deposit simulation bench 10 also includes an air supply system 16 including an air supply conduit 18 fluidly connecting an air supply source 20 with the test chamber 12, and a liquid circulation loop 26 configured to circulate the engine system liquid through the test chamber 12. A temperature control subsystem 42 simulates an engine temperature within the test chamber 12, and a pressure control subsystem 46 simulates an engine pressure within the test chamber 12.

The carbon deposit simulation bench 10 may be set up by first simulating a temperature, such as an average engine temperature, of an engine surface within the test chamber 12 using the temperature control subsystem 42, and simulating a pressure, such as an average engine pressure, of the engine surface within the test chamber 12 using the pressure control subsystem 46. The carbon deposit simulation bench 10 may then be run for a predetermined period of time using a first baseline liquid. After circulating the first baseline liquid through the carbon deposit simulation bench 10 for the predetermined period of time, a first deposit signature, such as signatures 108 or 208, from the first baseline liquid within the test chamber 12 may be compared to an expected engine deposit signature, such as signatures 106 or 206, corresponding to the first baseline liquid. When evaluating the deposits formed on the high surface area test specimen 14 with expected deposits or, more specifically, when comparing signatures, it may be desirable to consider both the carbon and ash contents of the deposits and the carbon burn off profiles of the deposits.

The above described steps may be repeated until the first deposit signature, such as exemplary deposit signatures 108 or 208, from the first baseline liquid matches the expected engine deposit signature, such as signatures 106 or 206. If the deposit signatures do not match, as shown in FIG. 6, it may be desirable to adjust one or more of the parameters of the carbon deposit simulation bench 10 and perform another simulation. When the deposit signatures match, it may be determined that a good simulation has been conducted. Once it is determined that a good simulation has been conducted, it may be desirable to calculate a mass of the deposits from the first baseline liquid on the high surface area test specimen 14. If applicable, it may be desirable to correlate the mass of deposits from the first baseline liquid on the high surface area test specimen 14 to a high level baseline or a low level baseline. If desirable, the carbon deposit simulation bench 10 may be run again using a second baseline liquid to establish an additional baseline.

The carbon deposit simulation bench 10 may be used to evaluate one or more liquids after the carbon deposit simulation bench 10 has been set up. In a similar manner to that described above, the carbon deposit simulation bench 10 may be used by first simulating an engine temperature, such as an average engine temperature, of an engine surface within the test chamber 12 using the temperature control subsystem 42, and simulating an engine pressure, such as an average engine pressure, of the engine surface within the test chamber 12 using the pressure control subsystem 46. The carbon deposit simulation bench 10 may then be run using a first engine system liquid for a predetermined period of time. A mass of deposits from the first engine system liquid on the high surface area test specimen 14 may be calculated and, if desirable, may be compared to a baseline mass of deposits. More specifically, for example, it may be desirable to compare the mass of deposits from the first engine system liquid to the high level baseline and the low level baseline. Additional engine system liquids may be similarly evaluated.

It should be appreciated that the carbon deposit simulation bench 10 and methods of use described herein provide means for evaluating the effects of engine system liquids, such as hydrocarbons, on specific engine surfaces. Specifically, the carbon deposit simulation bench 10 may be used to simulate operating conditions at the specific engine surfaces in order to evaluate the carbon deposition characteristics of the different engine system liquids. Utilizing the carbon deposit simulation bench 10, rather than evaluating effects produced in an actual engine after extended periods of use, provides a quicker and less costly way to evaluate the engine system liquids. For instance, once the simulation bench is properly set up, a five hour run on a new liquid may be useful in predicting actual engine surface deposits that would require the actual engine to run many hundreds of hours. Further, by analyzing results produced by the carbon deposit simulation bench 10, the selection of engine system liquids for use in an engine may be improved, thereby reducing some of the engine performance issues caused by utilizing engine system liquids producing high carbonaceous deposits.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A carbon deposit simulation bench for evaluating effects of an engine system liquid on an engine surface that experiences an engine pressure and an engine temperature, comprising:
a test chamber having a high surface area test specimen positioned therein;
an air supply system including an air supply conduit fluidly connecting an air supply source with the test chamber;
a liquid circulation loop configured to circulate the engine system liquid through the test chamber;
a temperature control subsystem for simulating the engine temperature within the test chamber; and
a pressure control subsystem for simulating the engine pressure within the test chamber.

2. The carbon deposit simulation bench of claim 1, wherein the engine pressure is an average engine pressure at the engine surface, and the engine temperature is an average engine temperature at the engine surface.

3. The carbon deposit simulation bench of claim 2, wherein the high surface area test specimen is a spring.

4. The carbon deposit simulation bench of claim 3, wherein the test chamber defines a shaft having a vertically aligned rod supported therein, and a pair of springs positioned around the vertically aligned rod and supported at a selected height along the vertically aligned rod using a retainer.

5. The carbon deposit simulation bench of claim 2, wherein the air supply system includes an air heating device disposed along the air supply conduit, and the temperature control subsystem includes an electronic temperature controller in communication with the air heating device and a temperature sensor.

6. The carbon deposit simulation bench of claim 2, wherein the temperature control subsystem is configured to maintain the average engine temperature corresponding to an engine piston surface.

7. The carbon deposit simulation bench of claim 6, wherein a material of the high surface area test specimen is the same as a material of the engine piston surface.

8. The carbon deposit simulation bench of claim 2, wherein the temperature control subsystem is configured to maintain the average engine temperature corresponding to a fuel injector component surface.

9. The carbon deposit simulation bench of claim 8, wherein a material of the high surface area test specimen is different from a material of the fuel injector component surface.

10. The carbon deposit simulation bench of claim 2, wherein the liquid circulation loop includes the following components fluidly connected in series: a liquid container, a liquid pump, the test chamber, a heat transfer device, a filter, a pressure regulator, and a separator.

11. A method for setting up a carbon deposit simulation bench, the carbon deposit simulation bench including a test chamber having a high surface area test specimen positioned therein, an air supply system including an air supply conduit fluidly connecting an air supply source with the test chamber, a liquid circulation loop configured to circulate an engine system liquid through the test chamber, a temperature control subsystem, and a pressure control subsystem, the method comprising the steps of:
simulating a temperature of an engine surface within the test chamber using the temperature control subsystem;
simulating a pressure of the engine surface within the test chamber using the pressure control subsystem;
running the carbon deposit simulation bench using a first baseline liquid for a predetermined period of time;
comparing a first deposit signature from the first baseline liquid within the test chamber to an expected engine deposit signature corresponding to the first baseline liquid; and
repeating steps one through four of the method at different combinations of temperature and pressure until the first deposit signature from the first baseline liquid matches the expected engine deposit signature.

12. The method of claim 11, further including calculating a mass of the deposits from the first baseline liquid on the high surface area test specimen.

13. The method of claim 12, further including correlating the mass of the deposits from the first baseline liquid on the high surface area test specimen to a high level baseline.

14. The method of claim 13, further including:
running the carbon deposit simulation bench using a second baseline liquid for the predetermined period of time;
calculating a mass of deposits from the second baseline liquid on the high surface area test specimen; and
correlating the mass of the deposits from the second baseline liquid on the high surface area test specimen to a low level baseline.

15. A method for evaluating an engine system liquid using a carbon deposit simulation bench, the carbon deposit simulation bench including a test chamber having a high surface area test specimen positioned therein, an air supply system including an air supply conduit fluidly connecting an air supply source with the test chamber, a liquid circulation loop configured to circulate the engine system liquid through the test chamber, a temperature control subsystem, and a pressure control subsystem, the method comprising the steps of:
simulating a temperature of an engine surface within the test chamber using the temperature control subsystem;
simulating a pressure of the engine surface within the test chamber using the pressure control subsystem;
running the carbon deposit simulation bench using the engine system liquid for a predetermined period of time;
calculating a mass of deposits from the engine system liquid on the high surface area test specimen; and
comparing the mass of deposits from the engine system liquid on the high surface area test specimen to a baseline mass of deposits.

16. The method of claim 15, wherein the comparing step includes:
comparing the mass of deposits to a high level baseline; and
comparing the mass of deposits to a low level baseline.

17. The method of claim 15, wherein the first simulating step includes maintaining an average engine temperature corresponding to an engine piston surface, and the second simulating step includes maintaining an average engine pressure corresponding to the engine piston surface.

18. The method of claim 17, further including providing a high surface area test specimen having a material that is the same as a material of the engine piston surface.

19. The method of claim 15, wherein the first simulating step includes maintaining an average engine temperature corresponding to a fuel injector component surface, and the second simulating step includes maintaining an average engine pressure corresponding to the fuel injector component surface.

20. The method of claim 19, further including providing a high surface area test specimen having a material that is different from a material of the fuel injector component surface.
